(19) United States
(12) Patent Application Publication
(10) Pub. No.: US 2005/0146982 A1
(43) Pub. Date: Jul. 7, 2005

(54) Quick blend module

(76) Inventors: Stephen John Carlson, Shorewood, MN (US); Steve Bickett, Minnetonka, MN (US)

Correspondence Address: The BOC Group, Inc.;Legal Services-Intellectual Property, 575 Mountain Ave., Murray Hill, NJ, 07974, US

(21) Appl. No.: 10/749,948

(22) Filed: Dec. 31, 2003

(51) Int. Cl. B01F 5/10

(52) U.S. Cl. 366/136; 366/163.2

(57) ABSTRACT

An apparatus and method for measuring and mixing liquids is described. First and second vessels are connected to an aspirator so that reduced pressure is produced in the second vessel as a first liquid flows to the first vessel. Reduced pressure motivates flow of a second liquid into the second vessel until a predetermined level is reached. A conduit opens between the first and second vessels. The aspirator draws liquid from the second vessel to the first vessel while the conduit allows liquid from the first vessel to flow to the second vessel. Thus, the liquids are mixed until a predetermined level of liquid in the first vessel is reached.

### BACKGROUND OF THE INVENTION

This invention relates generally to the measuring and mixing of chemicals in liquid form. In particular, an apparatus for rapidly measuring and mixing different liquids is disclosed.

In many industrial applications chemicals are supplied in liquid form. These chemicals may require mixing with other chemicals before use in a particular application. Some chemicals must be diluted with water before use. Many chemicals are produced and transported in their pure form but are used in a diluted or mixed form. Mixing of chemicals requires an apparatus that is capable of mixing in an accurate, clean, reliable, quick and economical manner.

Accuracy is required when mixing chemicals for certain applications. Modern process control requires that critical variables in a chemical process be maintained within control limits. The concentration of a particular chemical in a solution or the ratio of chemicals in a mixture may be such critical variables. Any change in these variables may cause serious problems for production using the chemicals.

Safety may require that the mixing of chemicals takes place in a contained area. Any leakage should not cause release of hazardous material. Therefore, mixing apparatus is generally contained in a cabinet. Because most mixing apparatus is bulky, a separate, dedicated cabinet is generally required. Sensors are also needed to monitor the apparatus during use so that leaks may be rapidly detected. These safety components are costly and increase the overall size of the apparatus.

Chemicals used in many industrial applications must be highly pure. Even small amounts of contamination may cause problems in sensitive applications. For example, in the semiconductor industry, particles of less than 1 micron in diameter may destroy semiconductor integrated circuits. Therefore, the components of a mixing apparatus must not add any significant contaminants. Generally, components that have moving parts are a source of particulate contamination. Friction between the moving parts and their surroundings may cause some particles to be generated. Reducing the number of moving parts in a system is thus desirable to reduce contamination.

In addition to causing particulate contamination, moving parts may cause reliability problems. Components such as pumps that have moving parts also generally have mechanical wear. Wear eventually causes components to fail, making such components undesirable. More complex systems generally have more elements that may fail and so suffer from more reliability problems than simpler systems with fewer components. Therefore, reducing the number of components, especially those with moving parts, is desirable in order to produce a more reliable apparatus.

Mixing certain chemicals may need to be accomplished quickly. Flows of 500 liters/hour to 4000 liters/hour are commonly required. Some prior art systems are slow because of the system used to measure and mix. Specifically, many systems first measure the chemicals to be mixed in dedicated measuring vessels. Measuring vessels are generally vessels of known volume with sensors that determine when particular levels of liquid in the vessels are reached. Then, after the measurement is completed, the chemicals are mixed in a dedicated mixing vessel. This means that measurement must be completed before mixing commences. For large batches, large vessels are used. These vessels take longer to fill, occupy more space and are more costly than smaller vessels.

Most examples of mixing apparatus include several costly features including a cabinet, pumps, sensors and a controller. Clearly, these components add to the initial cost of a mixing system. In addition, having more components results in a larger apparatus. Space is frequently at a premium in industrial production environments. Larger equipment requires larger facilities and thus adds cost. For example, in Semiconductor production facilities, space is at a premium because of the high cost of building and maintaining a cleanroom environment. Therefore, smaller, simpler equipment is desirable for economic reasons.

Some prior art mixing systems use volumetric measurement of liquids to be mixed. Generally, such systems use pumps to motivate the liquids through the system. Examples of such systems are given in U.S. Pat. Nos. 5,148,945, 5,330,072, 5,370,269, 5,417,346, 5,490,611, 5,632,960, 5,874,049, 5,803,599, 6,247,838 and 6,290,384. The liquid may be moved from a storage vessel by pressurizing the storage vessel or may be drawn to a measurement vessel by creating a vacuum in the measurement vessel using a vacuum pump. From the measurement vessel the chemical is generally transferred to a mixing vessel. This transfer is also generally done using a pump. In the mixing vessel the chemical may be combined with other liquids. Mixing in the mixing vessel is usually aided by some mechanical apparatus. For example, a paddle mechanism, magnetic-driven stirring device or vortex generating apparatus may be used to thoroughly mix the liquids. Measurement may also be based on the weight of fluid in the vessels instead of the volumes.

### SUMMARY OF THE INVENTION

A mixing apparatus and method of mixing liquids is described. The apparatus comprises two vessels and an aspirator. A first vessel is connected to a first fluid supply through the aspirator. The aspirator is connected so that it can produce reduced pressure in the second vessel as fluid flows into the first vessel. Both vessels are also connected together so that fluid may flow between them through a conduit when a valve is opened. The vessels have sensors that can accurately determine when particular levels of liquid have been reached. Alternatively, the weight of liquid in the vessels may be measured.

As a first liquid flows through the aspirator into a first vessel, the aspirator creates reduced pressure in the second vessel that draws a second liquid into the second vessel. When the level of the second liquid in the second vessel reaches the required level, the flow into the second vessel is stopped. A conduit between the first vessel and the second vessel is opened. This allows fluid flow between the two vessels. As the first liquid continues to flow through the aspirator, the liquid in the second vessel is drawn through the aspirator and into the first vessel. At the same time, liquid in the first vessel flows through the conduit into the second vessel. This circulation between the vessels and the aspirator mixes the two liquids. Mixing is done at the same time that the first liquid is flowing into the apparatus. The flow of the first liquid is stopped when the required level is reached. Thus, mixing and measuring are performed in parallel in this example, allowing the whole operation to be performed rapidly.

The apparatus uses few parts. Because mixing takes place in the vessels used for measuring, no dedicated mixing vessel is required. The aspirator uses the flow of the first liquid to motivate the second liquid, so no pump is required for the second liquid. Because the flow of liquids between the vessels and through the aspirator mixes the liquids, no stirring mechanism is required. With no pump, mixing vessel or stirring mechanism the apparatus may be very small, clean and reliable. The apparatus may be small enough to be placed in a cabinet with other equipment so that no dedicated cabinet or sensors are required. This further reduces both the initial cost and the operating cost of the apparatus.

### BRIEF DESCRIPTION OF THE DRAWINGS

FIG. 1 illustrates a quick blend apparatus according to one embodiment of the present invention.

FIG. 2 illustrates a quick blend apparatus as a first fluid is introduced into a first vessel.

FIG. 3 illustrates a quick blend apparatus as a first fluid is introduced into a first vessel and a second fluid is introduced into a second vessel.

FIG. 4 illustrates a quick blend apparatus as a first fluid and a second fluid approach the mixing state.

FIG. 5 illustrates a quick blend apparatus during mixing of the first fluid and the second fluid.

FIG. 6 illustrates a quick blend apparatus at completion of mixing and measuring.

FIG. 7 shows a mixing apparatus having sensors to monitor concentration.

### DESCRIPTION OF EXEMPLARY EMBODIMENTS

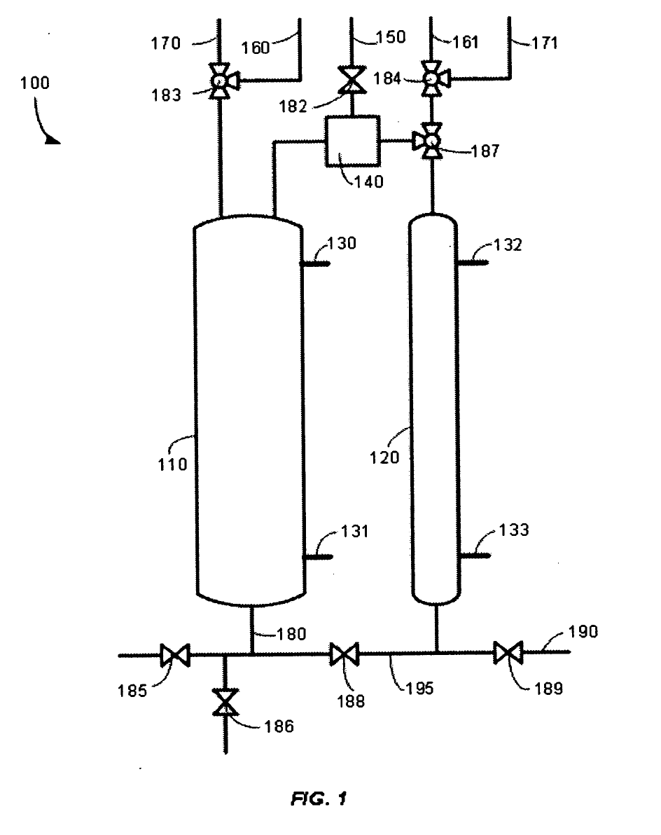

FIG. 1 shows a mixing apparatus 100 of the present invention. A first vessel 110 and a second vessel 120 are shown. In this example the vessels are elongated vertically. First vessel 110 has sensors 130, 131 to determine the liquid level in the first vessel 110. Second vessel 120 has sensors 132, 133 to determine liquid level in the second vessel 120. For example, the sensor 130, near the top of the first vessel 110, may be used to determine when the first vessel 110 is filled to a level that is designated as “full.” Various types of sensors may be used for sensors 130-133, including optical, capacitive, load-cell and other sensors capable of determining liquid level.

An aspirator 140 is shown connected to a first fluid supply 150 through a valve 182. The aspirator 140 is a device that uses a constriction in a fluid flow to produce reduced pressure. Reduced pressure may be any pressure that is less than the ambient pressure at the aspirator. Reduced pressure may be considered a partial vacuum. Reduced pressure may be used to draw fluid to the aspirator by connecting a vessel that contains fluid to the reduced pressure. An example of an aspirator that may be used in this apparatus is a Galtek® Aspirator, supplied by Entegris Inc. Aspirators may be supplied with a check valve or without one. For this application a check valve is not necessary. Other aspirators that work with liquids and gasses may also be used. The aspirator 140 is connected so that fluid may pass through it from the first fluid supply 150 to the first vessel 110. The aspirator is also connected to the second vessel 120 so that reduced pressure in the aspirator 140 may be applied to the second vessel 120.

The first vessel 110 is connected through the aspirator 140 to a first fluid supply 150 so that it may be filled with a first fluid. The first fluid may be deionized water (DI), for example. Typically DI will be supplied under pressure that is sufficient to motivate its flow into the apparatus 100. For example, DI is typically available through a “house” supply similar to a domestic water supply. The first vessel 110 also has a gas supply 160 to allow the first vessel 110 to be connected to a source of high pressure gas, for example, pressurized nitrogen gas (N2). The first vessel 110 is also connected to a gas exhaust 170 so that excess pressure may be released. The gas supply 160 and gas exhaust 170 are controlled by a valve 183 so that either the gas supply 160 or the gas exhaust 170 may be connected to the first vessel 110. Thus, the pressure in the first vessel 110 may be changed as required. The first vessel 110 has an outlet 180 that allows the contents of the first vessel 110 to flow out of the first vessel 110. A valve 185 allows fluid from the outlet 180 to flow to a tank, for example, a daytank where it may be stored before use or fluid from outlet 180 may flow to a point of use such as a semiconductor tool. A valve 186 allows fluid from the outlet 180 to flow to a drain. This allows the fluid in the first vessel 110 to be disposed of. This may be necessary if there are any errors in mixing or if there is contamination of the fluid in the first vessel 110.

The second vessel 120 is connected to the aspirator 140 so that as fluid flows through the aspirator 140 from the first fluid supply 150 to the first vessel 110, reduced pressure may be produced in the second vessel 120. This connection between the aspirator 140 and the second vessel 120 is controlled by a valve 187 that may be closed if required. Thus, the second vessel 120 may be isolated from the aspirator 140.

The second vessel 120 is connected to the aspirator 140 at one end and to a chemical supply 190 at the other end. The chemical supply 190 is controlled by a chemical supply valve 189. For example, the chemical may be hydrofluoric acid (HF) or ammonium hydroxide (NH4OH). The second vessel 120 also has a gas supply 161 to allow the vessel to be connected to a source of high pressure, for example, pressurized nitrogen gas, N2. The second vessel 120 may also be connected to gas exhaust 171 so that excess pressure may be released. The gas supply 161 and gas exhaust 171 are controlled by valve 184 so that either the gas supply 161 or the gas exhaust 171 may be connected to the second vessel 120. Valve 187 is in series with valve 184 and allows the gas supply 161 or gas exhaust 171 to be connected to second vessel 120 when aspirator 140 is not connected to second vessel 120. Alternatively, the second vessel 120 may be isolated from both gas supply 161 and gas exhaust 171. Thus, the pressure in the second vessel 120 may be changed as required.

The bottom of the first vessel 110 is connected to the bottom of the second vessel 120 by a conduit 195. The conduit 195 has a valve 188 so that the conduit 195 may be opened when needed to connect the first vessel 110 and the second vessel 120. The conduit 195 may also be closed to isolate the first vessel 110 and second vessel 120 from each other.

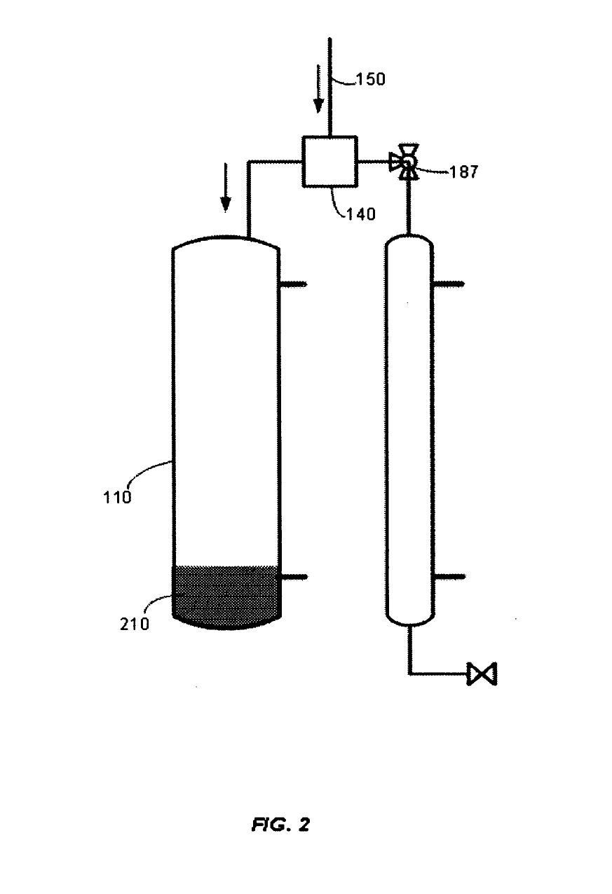

An example of how the apparatus 100 operates to measure and mix liquids will now be illustrated. In this example, a chemical liquid (chemical) is mixed with DI. Typically, more DI than chemical is required. Ratios of DI to chemical from 200:1 to 2:1 may be achieved as described in this embodiment. Ratios as low as to 1:1, may be achieved as described later in another embodiment. FIGS. 2-6, show successive stages of the process. For clarity, only the parts of the apparatus 100 that are relevant to the illustrated step are shown in each drawing.

FIG. 2 shows the start of the measuring and mixing process. DI is directed from first fluid supply 150 through the aspirator 140, into the first vessel 110. The flow of DI through the aspirator 140 produces reduced pressure in the aspirator 140. Valve 187 is open between aspirator 140 and the second vessel 120 so that reduced pressure is applied to second vessel 120. As DI flows into the first vessel 110, DI collects in the bottom of the first vessel 110 to form a filled volume 210 in the first vessel 110.

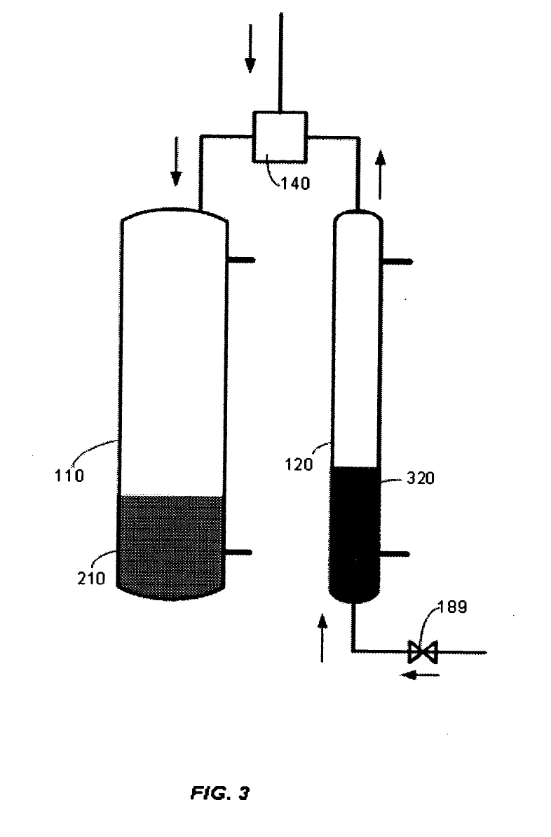

FIG. 3 shows the filling of the second vessel 120. In this step, the chemical supply valve 189 opens to allow chemical to enter the second vessel 120. Because of the low pressure generated by the aspirator 140, the chemical is drawn into the second vessel 120 without the need for a pump. A filled volume 210 of the first vessel 110 is filled with DI while a filled volume 320 is in the second vessel 120 is filled with chemical. The filled volumes 210, 320 expand as more DI and chemical enter the apparatus 100. The first vessel 110 and the second vessel 120 are isolated from each other at this stage so no mixing of DI and chemical takes place.

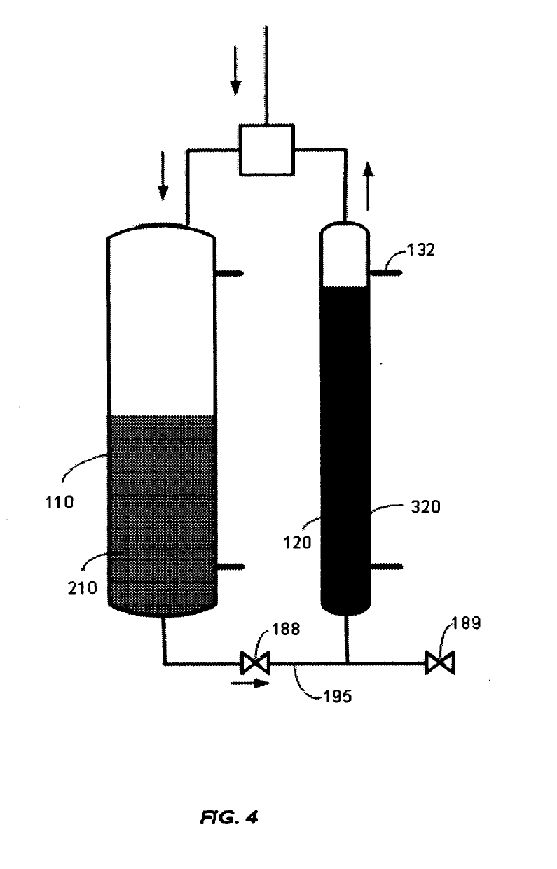

FIG. 4 shows the end of the filling of the second vessel 120. At this point, the sensor 132 detects that the filled volume 320 in the second vessel 120 has reached a predetermined volume. Chemical supply valve 189 closes and thus stops the supply of chemical to the second vessel 120. Valve 188 opens to allow fluid flow in the conduit 195 between the first vessel 110 and the second vessel 120. At this point, although the second vessel 120 is full, the first vessel 110 is not full. Typically, the first vessel 110 is larger and takes more time to fill. In this example, more DI than chemical is required. Therefore, DI is directed to the first vessel 110. In other mixing applications, whichever liquid is required in larger volume would be directed to the first vessel 110.

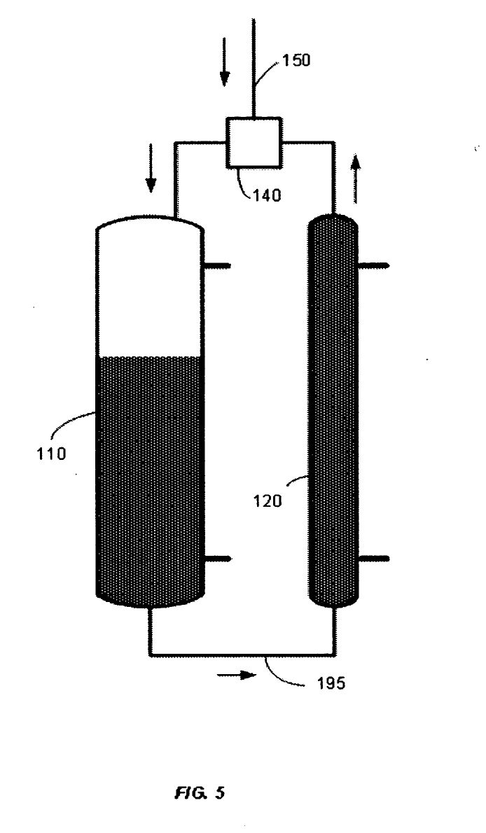

FIG. 5 illustrates fluid flow between the first vessel 110 and second vessel 120. Because DI is still flowing into the first vessel 110 in FIG. 5, the aspirator 140 still produces reduced pressure in the second vessel 120. This reduced pressure now draws fluid from the first vessel 110 through the conduit 195 and into the second vessel 120. The DI mixes with the chemical in the second vessel 120. When the second vessel 120 fills completely, liquid is drawn from the second vessel 120 into the aspirator 140. The liquid in the second vessel 120 is mostly chemical at this point, though some DI has entered through the conduit 195. In the aspirator 140, the liquid from the second vessel 120 mixes with the DI that is being supplied to the aspirator 140 from the fluid supply 150. The mixture of DI and liquid from the second vessel 120 passes from the aspirator 140 to the first vessel 110. Thus, liquid circulates through the first vessel 110, the conduit 195, the second vessel 120, the aspirator 140 and then back to the first vessel 110. This is shown by the anticlockwise circulation indicated in FIG. 5. This circulation is powered by the flow of DI from the fluid supply 150. Thus, no pump is required. The circulation mixes the DI and the chemical. In particular, the aspirator 140 serves to mix the incoming DI with the liquid that is already present in the apparatus 100. This mixing continues as long as DI flows into the apparatus 100 through fluid supply 150.

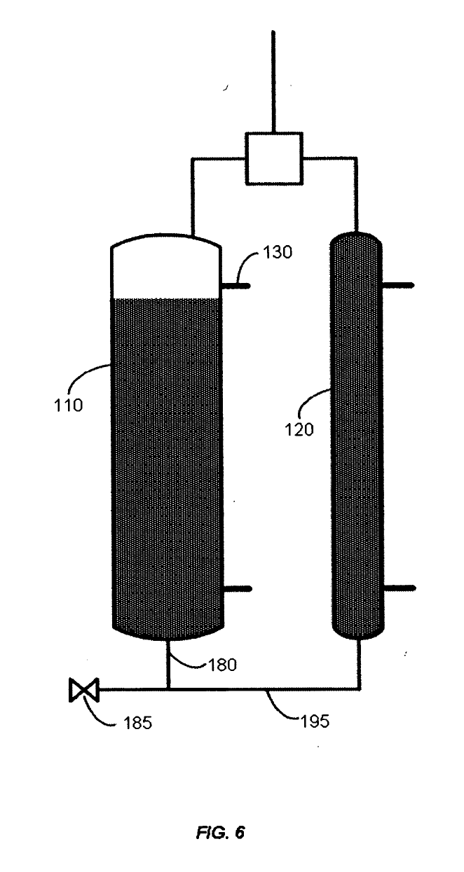

FIG. 6 shows the end of the mixing process. The level of liquid in the first vessel 110 has reached the point where the sensor 130 detects that a predetermined level has been reached. This level corresponds to the volume of DI required to dilute the chemical in the required ratio. This level is calculated from the total filled volume, which includes the volume of the first vessel 110, second vessel 120 and all the other volumes that are filled at this point including the aspirator 140, valves 187, 188 and connecting lines including lines 180, 195. The total filled volume minus the volume of chemical is the volume of DI in the system. Thus, for example, where the desired ratio is 5:1, the predetermined level is the point at which the total filled volume is six times that of the volume of chemical that was supplied. Therefore, the volumes of all these components must be known with great precision. The mixing is completed at this stage and the mixed liquid is ready to be used. Typically, the liquid is delivered to a tank through valve 185. The liquid may be gravity fed to a tank or pressurized gas supplied from either valve 160 or valve 161 may be used to pressurize the system to motivate liquid to flow out through valve 185. Alternatively, a pump may be used to motivate liquid to flow.

In another embodiment, a lower ratio of DI to chemical may be achieved by using gas flow through valve 182, for example Nitrogen (N2) to aspirate the fluid from fluid supply 190 to the second vessel 120 to the first vessel 110 of FIG. 1. Typically, using a first liquid to aspirate and mix with a second liquid (for example, using DI to aspirate and mix with chemical as above) requires at least twice as much of the first liquid because it has to draw the second liquid into its vessel and then continue flowing to mix the two liquids. By using a gas, this constraint may be avoided. Gas flow through the aspirator 140 may be used to draw the second liquid into the second vessel 120 and/or to circulate liquid through the system. Powering the system with gas instead of using one of the liquids to be mixed allows mixing of liquids in any ratio. The gas is supplied to the aspirator 140 through the fluid supply 150. The gas passes through the aspirator 140 and into the first vessel 110. To prevent a buildup of pressure in the first vessel 110, the gas exhaust 170 may be opened via valve 183. Thus, gas flows out of the first vessel 110 through the gas exhaust 170 while liquid drawn from the second vessel 120 through the aspirator 140 falls to the bottom of the first vessel 110.

Pressurized gas may be used in another way to mix the liquid after the predetermined level has been reached in the first vessel 110. At this point, no more liquid is needed. If the mixed liquids require more mixing, this may be done by alternately pressurizing the first vessel 110 and then pressurizing the second vessel 120 to force the mixed liquid from one vessel to the other.

In another embodiment, several liquids may be mixed together. The apparatus 100 described above may be modified to add several chemical supply lines to the chemical supply valve 189. Additional sensors may be added to the second vessel to allow accurate measurement at several levels. For example, a first chemical could be drawn into the first vessel to a first level. Then, the supply of the first chemical could be stopped and the supply of a second chemical started. The second chemical could then be drawn into the second vessel until a second level is reached. This could be repeated for a third chemical and so on.

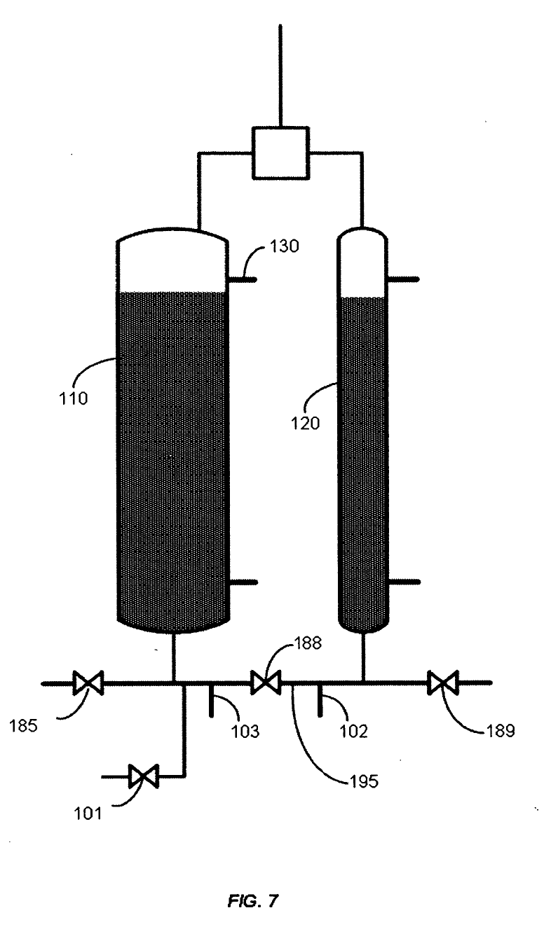

When liquids are mixed it is desirable to know the chemical concentration of the mixture. Thus, metrology apparatus may be attached directly to mixing apparatus 100 or may be added as a separate unit. FIG. 7 shows sensors 102 and 103 mounted to conduit 195. Sensors 102 and 103 may be conductivity monitors that determine the chemical concentration of liquid within conduit 195 by measuring its electrical conductivity. Only one sensor, 102 or 103 may be required. Either location shown will provide the chemical concentration of liquid as it passes from vessel to vessel through conduit 195. Thus, sensors 102 and/or 103 may measure the concentration during the mixing or “sloshing” of liquid from one vessel to another to determine when mixing is completed. Valve 101 provides a means to take a sample from conduit 195 and perform metrology offline. This provides an alternative way to determine chemical concentration of liquid in conduit 195.

In another embodiment, the second vessel 120 could be filled more than once with one or more liquids. For example, the second vessel 120 could be filled first with a first chemical, then emptied to the first vessel 110, then filled with a second chemical and so on. Emptying of second vessel 120 may be achieved by pressurizing 120 with gas through valve 161 to motivate liquid to flow through conduit 195 to vessel 110.

In another embodiment, several liquids may be mixed in an apparatus where each liquid has its own dedicated vessel. In FIG. 1 the second vessel 120 is dedicated to the second liquid. If additional chemicals are required, additional vessels, similar to the second vessel, may be added. Thus, several vessels may be connected in parallel, each with its own chemical supply.

The blending apparatus 100 may be made small enough to fit in a cabinet occupied by a daytank. This requires no additional cabinet because the daytank is already enclosed in a cabinet. Safety sensors are already in place in the cabinet so additional sensors are not required either. The apparatus may be used to top-up the daytank. This frequent top-up with small batches of chemical mixture may reduce batch-to-batch inconsistency in the daytank because of the effects of statistical averaging over a larger number of smaller batches.

The blending apparatus 100 described may be configured to operate in an automated manner by selecting valves 182-189 that may be operated by a controller. For example, electrically or pneumatically actuated valves may be used for this purpose. The controller used may be the controller of the daytank. The sensors 130-133 used are level sensors. However, other sensors could be used that can accurately measure the amount of liquid in a vessel. For example optical sensors may be used or the weight of liquid may be sensed.

Although the various aspects of the present invention have been described with respect to particular embodiments, it will be understood that the invention is entitled to full protection within the full scope of the appended claims.

1. A measuring and mixing apparatus, comprising:
a first vessel having at least one sensor to determine an amount of liquid in the first vessel;
a second vessel having at least one sensor to determine an amount of liquid in the second vessel;
an aspirator that produces reduced pressure in the second vessel as a first fluid flows through the aspirator to the first vessel;
a fluid inlet in the second vessel that allows a second fluid to enter the second vessel; and
a fluid conduit connecting the first vessel and the second vessel.

2. The apparatus of claim 1 further comprising a first valve to control fluid flow through the fluid conduit.

3. The apparatus of claim 1 further comprising a second valve to control fluid flow of the second fluid into the second vessel.

4. The apparatus of claim 1 further comprising a controller that controls the first valve and the second valve.

5. The apparatus of claim 1 wherein the first vessel and the second vessel each have a gas exhaust conduit and a valve to control gas flow through the gas exhaust conduit.

6. The apparatus of claim 1 wherein the first vessel and the second vessel each have a gas supply and a valve to control gas flow through the gas supply.

7. The apparatus of claim 1 wherein the first vessel and the second vessel are elongated in a vertical direction and each has an upper portion and a lower portion, the aspirator connects to the upper portion of the first vessel and the upper portion of the second vessel and the fluid conduit connects to the lower portion of the first vessel and the lower portion of the second vessel.

8. A method of measuring and mixing a first liquid and a second liquid, comprising:
flowing a first liquid into a first vessel to produce a reduced pressure in a second vessel;
flowing a second liquid into the second vessel;
stopping the flow of the second liquid into the second vessel when a predetermined amount of the second liquid is reached in the second vessel;
opening a fluid conduit between the first vessel and the second vessel;
drawing the second liquid from the second vessel through the aspirator into the first vessel; and
flowing the first liquid from the first vessel through the fluid conduit into the second vessel.

9. The method of claim 8, wherein the first liquid flowing into the first vessel produces a reduced pressure in the second vessel using an aspirator.

10. The method of claim 8 further comprising stopping the flow of the first liquid when the amount of liquid in the first vessel reaches a predetermined amount.

11. A method of measuring and mixing a first liquid and a second liquid, comprising:
introducing the first liquid into a first vessel and introducing the second liquid into a second vessel, the first vessel and the second vessel having sensors that allow detection of the amount of liquid in the first vessel and in the second vessel;
aspirating the second liquid from the second vessel to the first vessel thereby causing the first liquid to flow from the first vessel to the second vessel.

12. The method of claim 11 wherein, the second liquid is introduced while the first liquid is being introduced.

13. The method of claim 11 wherein, the first liquid is introduced into the first vessel through an aspirator causing aspiration of the second liquid from the second vessel to the first vessel.

14. The method of claim 11 wherein, the second liquid is aspirated from the second vessel to the first vessel by flowing gas through an aspirator

15. A liquid measuring and mixing apparatus, comprising:
a first measurement vessel;
a second measurement vessel;
an aspirator capable of producing reduced pressure in the second vessel as a first liquid flows through the aspirator to the first vessel;
a fluid inlet in the second vessel that allows a second liquid to enter the second vessel;
a fluid conduit connecting the first vessel and the second vessel;
a first valve controlling fluid flow in the fluid conduit;
a second valve that controls flow of the second liquid through the fluid inlet;
a controller that controls the first valve and the second valve; and
a cabinet that encloses the first vessel, the second vessel and the aspirator.

16. The apparatus of claim 15 wherein the cabinet also encloses a daytank and wherein the contents of the first vessel and the second vessel may be emptied into the daytank.

17. The apparatus of claim 16 further comprising sensors within the cabinet that sense hazardous conditions within the cabinet.

18. A measuring and mixing apparatus, comprising:
a first vessel having at least one sensor to determine the amount of liquid in the first vessel;
a second vessel having at least one sensor to determine the amount of liquid in the second vessel;
an aspirator that produces reduced pressure in the second vessel as a first fluid flows through the aspirator to the first vessel;
a fluid inlet in the second vessel that allows a second fluid to enter the second vessel;
a fluid conduit connecting the first vessel and the second vessel;
wherein the first vessel and the second vessel are elongated in a vertical direction and each has an upper portion and a lower portion, the aspirator connects to the upper portion of the first vessel and the upper portion of the second vessel and the fluid conduit connects to the lower portion of the first vessel and the lower portion of the second vessel;
a source of a liquid chemical that is pressurized; and
wherein mixing of liquids in the first and second vessels may be performed by alternately transferring liquid from the first vessel to the second vessel and from the second vessel to the first vessel.

19. The apparatus of claim 1 further comprising at least one sensor attached to the fluid conduit connecting the first vessel and the second vessel that measures a chemical concentration of fluid in the fluid conduit.

20. The method of claim 8 further comprising measuring the chemical concentration of a fluid in the fluid conduit.

21. The method of claim 11 further comprising motivating liquid to flow alternately from the first vessel to the second vessel and from the second vessel to the first vessel.

22. The method of claim 21 wherein motivating liquid to flow is by alternately pressurizing the first vessel and the second vessel.
